(19) United States
(12) Patent Application Publication
(10) Pub. No.: US 2005/0131965 A1
(43) Pub. Date: Jun. 16, 2005

(54) System and method for replicating data

(76) Inventors: Wai T. Lam, Jericho, NY (US); Xiaowei Li, Hauppauge, NY (US)

Correspondence Address: Kaye Scholer LLP, 425 Park Avenue, New York, NY, 10022-3598, US

(21) Appl. No.: 10/733,553

(22) Filed: Dec. 11, 2003

(51) Int. Cl. G06F 12/16

(52) U.S. Cl. 707/204; 711/162; 711/135

(57) ABSTRACT

The method traverses a storage device, performing read operations on each allocated data block on the device, recording each I/O access to the device resulting from the read operations, and identifying the data blocks involved in each I/O access to determine which blocks contain valid data. The data blocks that contain valid data are then replicated.

### BACKGROUND OF THE INVENTION

This invention relates generally to a system and method for replicating data. More particularly, this invention relates to replicating data on a block level.

Over time in a typical computer environment, large amounts of data are written to and retrieved from storage devices connected to the computer. As more data are exchanged with the storage devices, it becomes increasingly difficult for the data owner to reproduce these data if the storage devices fail. One method of protecting data, replication, is performed, e.g., by backing up the data from a system drive to a backup drive.

When replicating data on a block level, it is efficient to replicate only the data needed to ensure data integrity. Typically, the two storage devices (e.g., drives) involved in the replication process are compared and their differences noted, and only the blocks containing differences are replicated. This scheme works well when the two devices are similar and their differences relatively small compared to the size of the system storage device. On the other hand, if the two devices have entirely different contents, then their differences may include virtually the entire system storage device itself, so no efficiencies can be realized.

Even though in such a case replication cannot take advantage of the differences between the two devices, some optimization can still occur to avoid replicating every block in the system storage device. This is because not all data blocks are used or contain valid data, and replication is only concerned with blocks that do contain legitimate data. Other data blocks may still be different on the two devices, but if they are considered unallocated, their contents are meaningless and will be replaced in any case when the blocks are allocated for use.

Thus, so long as the replication process knows which blocks contain data, there can be some optimization. However, conventional replication processes do not know such information at any given moment, especially when a system storage device may have been used by different operating systems or file systems. Due to such “blindness,” conventional block level replication has often resorted to replicating the entire system device during a complete replication process. This replication suffers the disadvantages that come with such brute force procedure, e.g., introducing extra I/O traffic. In addition, if replication is performed over a network, the entire system device contents will be transmitted through the network, which uses up available network bandwidth.

One way to replicate data is to use a method such as that found in U.S. Pat. No. 6,356,977 to Ofek. This patent discloses on-line, real-time data migration from an existing storage device to a replacement storage device. The host system requests a data transfer and the replacement storage device, using a table that identifies which data elements have migrated, determines whether the data elements have migrated to the replacement storage device. If so, the elements do not migrate again. If they have not yet migrated, the replacement storage device migrates the requested data elements.

Another way to replicate data is found in U.S. Pat. No. 6,581,143 to Gagne et al., which discloses a data processing method and apparatus for enabling concurrent access to replicated data. Data on a standard device is replicated to other storage devices. The standard device includes at least two tables to monitor the operation of the standard device. The replicating devices also include tables to identify the status of those devices, allowing multiple copies of data to be altered and updated.

Neither of these methods identifies valid data prior to replication. The problem identified above, performing block level replication where the entire system device needs to be replicated because of a lack of information on which blocks on the device actually contain valid data, can be alleviated if the replication process can identify the blocks containing valid data in a storage device.

### SUMMARY OF THE INVENTION

The present invention solves this and other problems by using a data traversing software program to gather necessary information about data blocks on the system storage device, enabling the replication process to selectively replicate only the blocks containing valid data. The method “traverses” the storage device by performing a read operation on each allocated data block on the device and then records each I/O access to the device resulting from the read operation, identifying the data blocks involved in each I/O access to determine which blocks contain valid data and replicating the data blocks that contain valid data. The read operation may include reading metadata associated with files on the device. Such metadata may include file names, access permissions to the files, and creation and modification dates of the files. In addition, the cache on a computer associated with the device may be cleaned prior to performing read operations to ensure that every I/O access can be recorded.

The system of the present invention includes a storage device, a first software program that performs a read operation on each allocated data block on the device, and a second software program that records each I/O access to the device resulting from the read operation. Preferably, a computer is associated with the storage device and the first software program may reside on the computer. The first software program may also clean the computer's cache prior to performing read operations. The second software program may also manage the storage needs of the computer.

In one embodiment, the method operates on a storage device connected to a computer. In another embodiment, the method operates on a storage device provided by a storage management system or a storage server, and which is associated with the computer as a real or virtual device. The several steps of the method may be performed by a software program that resides on the computer and/or by the storage management system or storage server.

While the device is being traversed, a list is created containing all the blocks on the device that were accessed during the traversal, which comprises all the blocks that contain valid data. The list of blocks can now be used in the replication process where only the blocks included in the list will be replicated, thus optimizing the replication process.

Additional advantages of the invention will be set forth in the description which follows, and in part will be apparent from the description, or may be learned by practice of the invention. The advantages of the invention may be realized and obtained by means of the instrumentalities and combinations particularly pointed out in the appended claims.

### BRIEF DESCRIPTION OF THE DRAWINGS

The accompanying drawings, in which like reference numerals represent like parts, are incorporated in and constitute a part of the specification. The drawings illustrate presently preferred embodiments of the invention and, together with the general description given above and the detailed description given below, serve to explain the principles of the invention.

FIG. 1 is a block diagram illustrating the entities involved in replicating a storage device in accordance with an embodiment of the present invention; and

FIG. 2 is a flowchart depicting the storage device traversal process for replicating data in accordance with an embodiment of the present invention.

### DETAILED DESCRIPTION

The present invention finds data blocks on a storage device having valid data and replicates only those data blocks, making the replication of an entire storage device more efficient. It does this by “traversing” through the file system on the device and recording I/O accesses. “Traversing” a storage device involves accessing each allocated data block on the device. The data blocks that could be accessed contain valid data and can be replicated. The process is described in more detail below.

While it is difficult to identify blocks with valid data on a block level, it is easy to identify such blocks on a file level. If a block contains valid data, then that block must be referenced by the associated client file system (the block could contain file data and/or metadata). Consequently, if there is a way to perform I/O operations on the entire file system and record relevant information on these operations, then all the data blocks on a storage device should be able to be identified because if a block contains data, it will be involved in at least one of the recorded I/O operations.

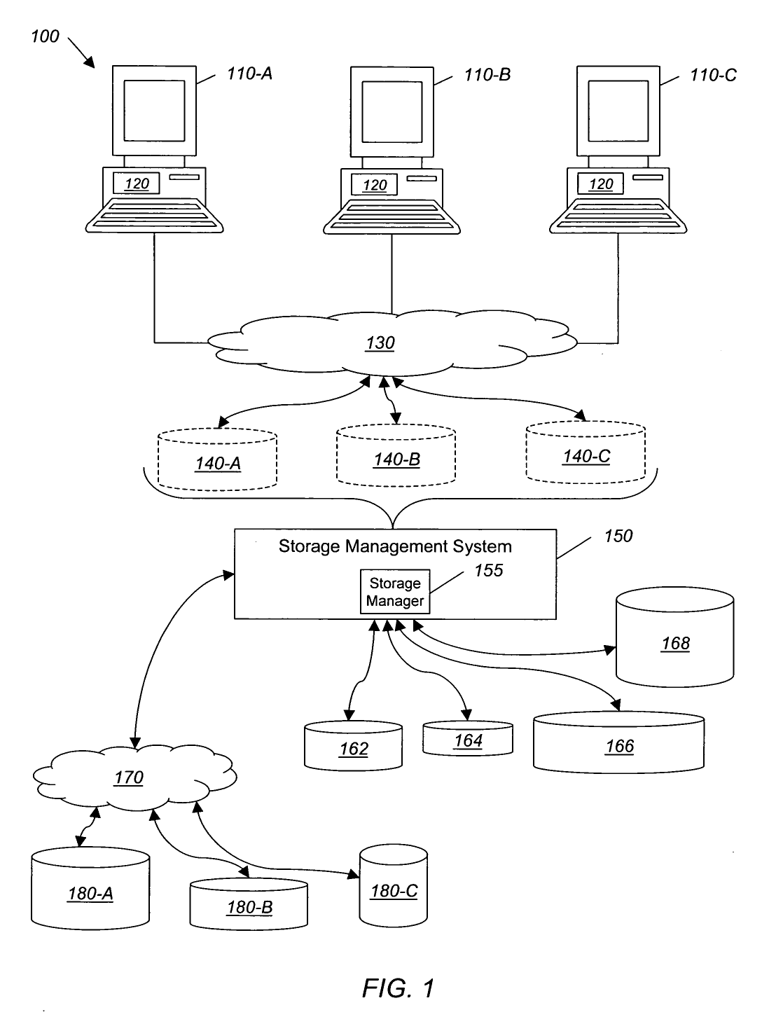

One embodiment of the present invention is shown in FIG. 1, in a storage area network environment. Storage area network 100 includes any number of client computers 110 (three of which, 110-A, 110-B, 110-C, are shown) connected to storage management system 150 via network 130. Client computers 110 can be standalone computers or servers having various uses, such as an e-mail server, a web server, etc. Each client computer 110 may use a different operating system, e.g., Windows, Linux, Solaris, AIX, etc. Each client computer 110 may use a different file system, such as NTFS (Windows NT file system), UFS (Unix file system), etc.

Storage management system 150 includes storage manager 155, typically software, and provides storage solutions, such as management services and storage devices, to client computers, and manages the actual storage devices. Attached to storage management system 150 are real storage devices 162, 164, 166, 168 that the storage management system uses to create virtual devices 140-A, 140-B, 140-C, etc. for the client computers. (Storage management system 150 may be realized using a storage server.) Typically, storage management system 150 presents each client computer with a virtual device—in FIG. 1, virtual devices 140-A, 140-B, 140-C are respectively presented to client computers 10-A, 110-B, 110-C. To client computers 110, virtual devices 140-A, 140-B, 140-C appear as locally-attached devices. Network 130 may be, for example, a local area network (LAN), a wide area network (WAN), a metropolitan area network (MAN), or an internetwork of computers, such as the Internet.

In an embodiment of the system of the present invention, storage management system 150 desires to create replica devices 180-A, 180-B, 180-C for client computer 110's virtual devices. Each replica device 180 is typically a virtual device (under the management of storage management system 150), but may be a real device (like 162, 164, 166, 168). Replica devices 180 may be directly connected to storage management system 150 or may be connected via a network, such as network 170. Alternatively, if there is a network 170 between replica devices 180 and storage management system 150, there may be a second storage management system (not shown) on the replica side of network 170 between network 170 and replicas 180. Like network 130, network 170 may be any type of network, including the Internet. As part of the invention, a first software program performs a read operation on each virtual device 140, and a second software program determines how much of each virtual device 140 has valid data to be replicated. This first software program 120 is typically installed on each client computer and is written for the operating system and file system specific to the client machine that uses the device that is to be replicated (i.e., each different operating system typically uses a different version of software program 120). The second software program can be storage manager 155.

Software program 120 runs on a client machine where it has knowledge of and access to the file system. When software program 120 operates, it systematically traverses through all of the used blocks on device 140 using the file system as the guide, performing read operations on each and every block. Meanwhile, software program 120 also communicates with storage manager 155 to record the I/O accesses it performs. Software program 120 notifies storage manager 155, which provides the device to be replicated, to start or stop recording I/O accesses on that device. The information recorded shows all the blocks that have been accessed during recording. Assuming all the data blocks have been accessed by software program 120, storage manager 155 will have recorded information on all the blocks required by the replication process.

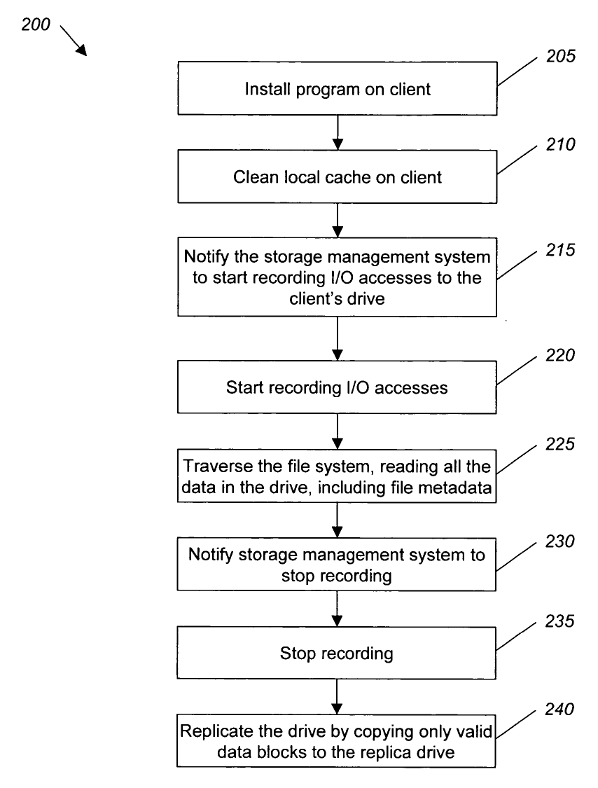

Flowchart 200 in FIG. 2 shows in more detail how the device traversing process for replicating data operates. First, in step 205 software program 120 is installed on the client computer 110 having a specific operating system and file system. In step 210, software program 120 cleans the local cache on client computer 110. By doing this, each I/O operation must access the virtual device 140 instead of some location in the cache. Because access to the cache is useless to the recording process, and it cannot be caught by storage manager 155, this step is necessary to ensure that storage manager 155 catches every I/O access performed during recording. In step 215, software program 120 notifies storage manager 155 to start recording I/O accesses to device 140 of client computer 110. In step 220, storage manager 155 starts recording I/O accesses to device 140. In step 225, software program 120 uses the file system to thoroughly traverse all of the data on device 140, performing read operations on all the allocated data blocks, including metadata associated with files. Metadata associated with a file is information about a file. Metadata includes the file name, access permissions, creation/modification dates, etc. Metadata is stored in memory along with the file itself. Software program 120 includes all necessary functionalities integrated to be able to reach all data blocks, even if some require special means of access. Special access may be required because there may be areas on device 140 that are not accessible using the regular file system functions. For example, extended attributes may require using system-specific functions to retrieve data, access control information may need a security API (application programming interface) to process data, etc. While software program 120 traverses device 140, storage manager 155 captures all I/O accesses to the device and records the data blocks involved in each access.

In step 230, software program 120 finishes traversing device 140 and signals storage manager 155 to stop recording, which, in step 235, storage manager 155 does. Storage manager 155 now has a list of all the blocks on the device that were accessed during the traversal by software program 120, and consequently all the blocks that contain valid data. In step 240, this list of blocks can be used in the replication process where only the blocks included in the list are replicated to device 180 by storage manager 155. Alternatively, storage manager 155 may send a copy of the data it manages to another storage management system, and that system will store the data on a storage device it manages.

By using the process of the present invention, block level replication involving two drastically different storage devices can still be optimized to eliminate unnecessary data transfers and be performed efficiently.

The present invention is not limited to the illustrative example of a storage area network managed by storage management system 150. The invention has broader application in any environment in which a storage device may be replicated. Thus, the invention can be used in a simple system having only a standalone computer and a real storage device, such as a hard drive or tape, with the software program traversing the storage device and a mechanism on the computer, such as a filter driver, recording the I/O accesses to the computer's device in order to identify valid data blocks. The filter driver is generally a software program that intercepts I/O operations to storage devices.

As indicated in FIG. 1, client computers 110 may be connected to storage management system 150 via a local or long-distance network 130, and replica device 180 may be connected to storage management system 150 via a local or long-distance network 170. However, instead of using networks 130 or 170, these connections may be direct connections.

Additional advantages and modifications will readily occur to those skilled in the art. Therefore, the present invention in its broader aspects is not limited to the specific embodiments, details, and representative devices shown and described herein. Accordingly, various changes, substitutions, and alterations may be made to such embodiments without departing from the spirit or scope of the general inventive concept as defined by the appended claims.

1. A method for replicating data from a storage device, comprising:
performing a read operation on each allocated data block on the storage device;
recording each I/O access to the storage device resulting from the read operation;
identifying the data blocks involved in each I/O access to determine which blocks contain valid data; and
replicating the data blocks that contain valid data.

2. The method according to claim 1, wherein the read operation includes reading metadata associated with files on the storage device.

3. The method according to claim 2, wherein the metadata includes the name of the file, access permissions to the file, the date of creation of the file, and dates of modification of the file.

4. The method according to claim 1, further comprising cleaning a cache on a computer associated with the storage device before performing any read operations.

5. A method for replicating data from a storage device associated with a computer, comprising:
cleaning a cache on the computer;
performing a read operation on each allocated data block on the storage device, including metadata associated with files on the storage device; and
notifying an apparatus to record each I/O access to the storage device resulting from the read operation,
wherein the data blocks involved in each I/O access are identified as having valid data and are replicated.

6. The method according to claim 5, wherein the apparatus is a software program.

7. The method according to claim 5, wherein the apparatus is a filter driver.

8. The method according to claim 5, wherein the apparatus is part of a storage management system.

9. The method according to claim 5, wherein the apparatus replicates the data.

10. A system for replicating data, comprising:
a storage device;
a first software program that performs a read operation on each allocated data block on the storage device; and
a second software program that records each I/O access to the storage device resulting from the read operation,
wherein the data blocks involved in each I/O access are identified as having valid data and are replicated.

11. The system according to claim 10, wherein the read operation includes reading metadata associated with files on the storage device.

12. The system according to claim 11, wherein the metadata includes the name of the file, access permissions to the file, the date of creation of the file, and dates of modification of the file.

13. The system according to claim 10, further comprising a computer associated with the storage device.

14. The system according to claim 13, wherein the first software program resides on the computer.

15. The system according to claim 13, wherein the first software program cleans a cache on the computer before performing any read operations.

16. The system according to claim 13, wherein the second software program manages the storage needs of the computer.

17. The system according to claim 10, wherein the second software program is a filter driver.

18. An apparatus for replicating data from a storage device associated with a computer, comprising:
a software program for performing a read operation on each allocated data block on the storage device and for notifying a second apparatus to record each I/O access to the storage device resulting from the read operation,
wherein the data blocks involved in each I/O access are identified as having valid data and are replicated.

19. The apparatus according to claim 18, wherein the software program cleans a cache on the computer before performing any read operations.

20. The apparatus according to claim 18, wherein the read operation includes reading metadata associated with files on the storage device.

21. The apparatus according to claim 20, wherein the metadata includes the name of the file, access permissions to the file, the date of creation of the file, and dates of modification of the file.

22. The apparatus according to claim 18, wherein the second apparatus is a second software program.

23. The apparatus according to claim 18, wherein the second apparatus is a filter driver.

24. The apparatus according to claim 18, wherein the second apparatus is part of a storage management system.
